(19) United States
(12) Patent Application Publication
(10) Pub. No.: US 2023/0407007 A1
(43) Pub. Date: Dec. 21, 2023

(54) PROCESS FOR CONTINUOUSLY PREPARING COPOLYAMIDES FROM LACTAMS, DIAMINES AND DIMER ACIDS

(71) Applicant: BASF SE, Ludwigshafen am Rhein (DE)

(72) Inventors: Rolf MINKWITZ, Ludwigshafen am Rhein (DE); Silke BIEDASEK, Ludwigshafen am Rhein (DE); Thomas KONSCHOLKA, Ludwigshafen am Rhein (DE); Cesar G. ORTIZ, Gordon, GA (US)

(21) Appl. No.: 18/038,037

(22) PCT Filed: Nov. 15, 2021
(86) PCT No.: PCT/EP2021/081638

§ 371 Date: May 22, 2023

(30) Foreign Application Priority Data
Nov. 24, 2020 (EP) 20209500.6

(51) Int. Cl. C08G 69/16; C08J 5/18

(52) U.S. Cl. CPC C08G 69/16; C08J 5/18; C08J 2377/02

(57) ABSTRACT

A process for continuously preparing copolyamides by copolymerizing at least one lactam (A) and monomers (M), comprising the steps of a) mixing at least one lactam (A) with monomers (M) at a temperature of 60 to 150° C. and b) passing the mixture obtained in step a) from the top downward through a vertical polymerization tube at polyamide-forming temperatures to obtain a copolyamide, wherein the monomers (M) comprise at least one C32-C40 dimer acid (B1) and at least one C4-C12 diamine (B2) and optionally at least one C4-C20 diacid (B3).

A process for continuously preparing copolyamides from caprolactam and salts of diamines and dicarboxylic acids dissolved in water is known from WO 2010/066769 A2 (BASF SE), in which an aqueous solution of caprolactam and salts of diamines and dicarboxylic acids, which were previously treated in a mixing apparatus and a helical tube evaporator, are fed to a VK tube from above. The two carboxyl groups of the dicarboxylic acids used are connected by an alkylene radical having four to twelve carbon atoms or a 1,3- or 1,4-phenylene radical. Dimer acids are not disclosed.

Copolyamides comprising C32-C40 dimerised fatty acids, diamines and caprolactam are disclosed in U.S. Pat. No. 5,013,518 A in quantities of 85.0 to 99.5 parts by weight of units of caprolactam and 0.5 up to 15 parts by weight of equimolar quantities of C32-C40 dimerised fatty acids and diamines. A continuous process is not disclosed in detail.

A copolyamide is described in WO 2018/050487 A1 (BASF SE), obtained by polymerizing a lactam, a C32-C40 dimer acid and a C4-C12 diamine. The polymerization is described in a stirred tank reactor. VK tube reactors and continuous procedures are not disclosed.

It is an object of the present invention to provide a continuous process for preparing optically improved, transparent copolyamides from lactams (A), especially caprolactam, and monomers (M), comprising at least one C32-C40 dimer acid (B1) and at least one C4-C12 diamine (B2) and optionally at least one C4-C20 diacid (B3).

This object is achieved by a process for continuously preparing copolyamides by copolymerizing at least one lactam (A) and monomers (M), comprising the steps of
a) mixing at least one lactam (A) with monomers (M) at a temperature of 60 to 150° C. and
b) passing the mixture obtained in step a) from the top downward through a vertical polymerization tube at polyamide-forming temperatures to obtain a copolyamide,

wherein the monomers (M) comprise at least one C32-C40 dimer acid (B1) and at least one C4-C12 diamine (B2) and optionally at least one C4-C20 diacid (B3).

Said object is also achieved by a process for continuously preparing copolyamides by copolymerizing at least one lactam (A) and monomers (M), comprising the steps of
a) mixing at least one lactam (A) with monomers (M) at a temperature of 60 to 150° C. and
b) passing the mixture obtained in step a) from the top downward through a vertical polymerization tube at polyamide-forming temperatures to obtain a copolyamide,
wherein the monomers (M) comprise at least one C32-C40 dimer acid (B1) and at least one C4-C12 diamine (B2) and optionally at least one C4-C20 diacid (B3) and wherein the mixing in step a) comprises a premixing of the at least one lactam (A) with component (B1) to obtain a premixture and subsequently adding component (B2) and optionally (B3) to the premixture.

Said object is further achieved by the copolyamides obtainable with this process and the use thereof to produce films, fibers and molded articles, in each case as defined and described in the patent claims and herein.

The comonomer units of the copolyamides obtainable with the inventive process show an improved distribution in the polymer chain, the copolymer preferably be a random copolymer.

Furthermore the process according to the invention has the advantage of providing copolyamides that can be further processed to give moldings, films or fibers, where the moldings, films or fibers, especially the moldings or films, have an unexpectedly high optical purity and a low number of defects (also called “fish eyes” in the technical field). Defects or fish eyes are fractures occurring on mechanical stress and are perceived negatively by consumers in transparent applications. The copolyamide prepared by the process according to the invention can be processed for example to give up to 2 mm-thick, transparent moldings or films, which is very surprising for a semi-crystalline material and is inter alia accompanied by advantages in coloring and color depth of the moldings or films.

According to the invention, the copolyamide is prepared by polymerizing at least one lactam (A), preferably in an amount in the range from 15 to 84% by weight, with monomers (M), preferably in an amount in the range from 16 to 85% by weight, where the monomers (M) comprise at least one C32-C40 dimer acid (B1) and at least one C4-C12 diamine (B2) and optionally at least one C4-C20 diacid (B3), where the sum total of the percentages by weight of components (A) and (M) adds up to 100% by weight.

According to another embodiment of the invention, the copolyamide is preferably prepared by polymerizing at least one lactam (A), preferably in an amount in the range from 18 to 83% by weight, with monomers (M), preferably in an amount in the range from 17 to 82% by weight, where the monomers (M) comprise at least one C32-C40 dimer acid (B1) and at least one C4-C12 diamine (B2) and optionally at least one C4-C20 diacid (B3), where the sum total of the percentages by weight of components (A) and (M) adds up to 100% by weight.

In the context of the present invention, “at least one lactam (A)” means either precisely one lactam (A) or a mixture of two or more lactams (A). Preference is given to precisely one lactam.

According to the invention preference is given preparing the copolyamide by polymerizing 40 to 83% by weight of the lactam (A) and 17 to 60% by weight of the monomers (M), particular preference is given to preparing the at least one copolyamide by polymerizing 60 to 80% by weight of the lactam (A) and 20 to 40% by weight of the monomers (M), where the monomers (M) comprise at least one C32-C40 dimer acid (B1) and at least one C4-C12 diamine (B2) and optionally at least one C4-C20 diacid (B3), where the percentages by weight of components (A) and (M) are in each case based on the sum total of the percentages by weight of components (A) and (M) and where the sum total of the percentages by weight of components (A) and (M) adds up to 100% by weight.

It will be apparent that the percentages by weight of the lactam (A) and of the monomers (M) are based on the percentages by weight of the lactam (A) and of the monomers (M) prior to the polymerization, i.e. when the lactam (A) and the monomer (M) have not yet reacted with one another. During the polymerization, the weight ratio of the lactam (A) and of the monomer (M) may possibly change.

According to the present invention it is preferred that the copolyamide prepared by the process according to the invention do not comprise polyether groups.

It is also preferred that the monomers (M) do not comprise polyoxyalkylene groups.

According to the invention it is furthermore preferred that components (B1), (B2) and (B3) do not comprise polyoxyalkylene groups.

In particular it is preferred that components (B1), (B2) and (B3) each do not comprise at least one polyoxyalkylene group.

Lactam (A)

Component (A) is at least one lactam.

Lactams are known per se to those skilled in the art. In the context of the present invention “lactams” are understood as meaning cyclic amides having 2 to 12, preferably 4 to 12, particularly preferably 5 to 8, carbon atoms in the ring.

Suitable lactams are, for example, selected from the group consisting of 3-aminopropanolactam (propio-3-lactam; β-lactam; β-propiolactam), 4-aminobutanolactam (butyro-4-lactam; γ-lactam; γ-butyrolactam), 5-aminopentanolactam (2-piperidinone; δ-lactam; δ-valerolactam), 6-aminohexanolactam (hexano-6-lactam; ε-lactam; ε-caprolactam), 7-aminoheptanolactam (heptano-7-lactam; ζ-lactam; ζ-heptanolactam), 8-aminooctanolactam (octano-8-lactam; η-lactam; η-octanolactam), 9-aminononanolactam (nonano-9-lactam; θ-lactam; θ-nonanolactam), 10-aminodecanolactam (decano-10-lactam; ω-decanolactam), 11-aminoundecanolactam (undecano-11-lactam; ω-undecanolactam) and 12-aminododecanolactam (dodecano-12-lactam; ω-dodecanolactam).

The lactams may be unsubstituted or at least monosubstituted. If at least monosubstituted lactams are used, the nitrogen atom and/or the ring carbon atoms thereof may bear one, two, or more substituents selected independently of one another from the group consisting of C1- to C10-alkyl, C5- to C6-cycloalkyl, and C5- to C10-aryl.

Suitable C1- to C10-alkyl substituents are, for example, methyl, ethyl, propyl, isopropyl, n-butyl, sec-butyl, and tert-butyl. A suitable C5- to C6-cycloalkyl substituent is for example cyclohexyl. Preferred C5- to C10-aryl substituents are phenyl and anthranyl.

Preference is given to using unsubstituted lactams, γ-lactam (γ-butyrolactam), δ-lactam (δ-valerolactam) and ε-lactam (ε-caprolactam) being preferred. Particular preference is given to δ-lactam (δ-valerolactam) and ε-lactam (ε-caprolactam), 6-aminohexanolactam (hexano-6-lactam; ε-lactam; ε-caprolactam) being especially preferred.

According to the invention the lactam (A) comprises 0 to 10% by weight of water, preferably 0.5 to 5% by weight of water, more preferably 1 to 3% by weight of water, most preferably 1.5 to 2% by weight of water, based on the total weight of lactam (A).

Monomers (M)

The monomers (M) comprise at least one C32-C40 dimer acid (B1) and at least one C4-C12 diamine (B2) and optionally at least one C4-C20 diacid (B3).

The monomers (M) comprise, for example, in the range from 45 to 55 mol % of component (B1) and in the range from 45 to 55 mol % of component (B2), based in each case on the sum total of the molar percentages of components (B1) and (B2), preferably based on the total molar amount of the monomers (M).

The monomers (M) preferably comprise in the range from 47 to 53 mol % of component (B1) and in the range from 47 to 53 mol % of component (B2), based in each case on the sum total of the molar percentages of components (B1) and (B2), preferably based on the total molar amount of the monomers (M).

The monomers (M) particularly preferably comprise in the range from 49 to 51 mol % of component (B1) and in the range from 49 to 51 mol % of component (B2), based in each case on the sum total of the molar percentages of components (B1) and (B2), preferably based on the total molar amount of the monomers (M).

The sum total of the molar percentages of components (B1) and (B2) present in the monomers (M) typically adds up to 100 mol %.

The monomers (M) may also additionally comprise a component (B3), at least one C4-C20 diacid.

When the monomers (M) additionally comprise component (B3), it is preferable that the monomers (M) comprise in the range from 25 to 54.9 mol % of component (B1), in the range from 45 to 55 mol % of component (B2) and in the range from 0.1 to 25 mol % of component (B3), based in each case on the total molar amount of the monomers (M).

Particularly preferably, the monomers (M) in that case comprise in the range from 13 to 52.9 mol % of component (B1), in the range from 47 to 53 mol % of component (B2) and in the range from 0.1 to 13 mol % of component (B3), based in each case on the total molar amount of the monomers (M).

Most preferably, the monomers (M) in that case comprise in the range from 7 to 50.9 mol % of component (B1), in the range from 49 to 51 mol % of component (B2) and in the range from 0.1 to 7 mol % of component (B3), based in each case on the total molar amount of the monomers (M).

When the monomers (M) additionally comprise component (B3), the molar percentages of components (B1), (B2) and (B3) typically add up to 100 mole percent.

The monomers (M) can be virtually anhydrous or else comprise water. The monomers (M) can comprise 0 to 10%, preferably 0.1 to 5% by weight of water, based on the sum total of the components of the monomers (M).

Components (B1) and (B2) and optionally (B3) of component (B) can react with one another to obtain amides. This reaction is known per se to those skilled in the art. Therefore, the monomers (M) can comprise components (B1) and (B2) and optionally (B3) in completely reacted form, in partially reacted form or in unreacted form. Preferably, the monomers (M) comprise components (B1) and (B2) and optionally (B3) in unreacted form.

In the context of the present invention, “in unreacted form” thus means that component (B1) is present as the at least one C32-C40 dimer acid and component (B2) as the at least one C4-C12 diamine, and component (B3), if present, as the at least one C4-C20 diacid.

If components (B1) and (B2) and any (B3) present have at least partially reacted with one another, components (B1) and (B2) and any (B3) present are at least partially in amide form.

Component (B1)

According to the invention, component (B1) is at least one C32-C40 dimer acid or preferably a C32-C40 dimer acid mixture, as defined herein.

In the context of the present invention, “at least one C32-C40 dimer acid” means either exactly one C32-C40 dimer acid or a mixture of two or more C32-C40 dimer acids.

In the context of the present invention, “C32-C40 dimer acid mixture” means the mixture obtainable by dimerizing unsaturated fatty acids selected from the group consisting of unsaturated C16 fatty acids, unsaturated C18 fatty acids and unsaturated C20 fatty acids, with unsaturated C18 fatty acids being particularly preferred, and optionally hydrogenating the mixture obtained.

Dimer acids are also referred to as dimer fatty acids. C32-C40 dimer acids are known per se to those skilled in the art and are typically prepared by dimerizing unsaturated fatty acids. This dimerization may be catalyzed by aluminas, for example.

The linking to give the dimer acid proceeds, according to the current state of knowledge, primarily by the Diels-Alder mechanism, and results, depending on the number and position of the double bonds in the fatty acids used to prepare the dimer acids, in mixtures of primarily dimeric products having cycloaliphatic, linear aliphatic, branched aliphatic, and also C6-aromatic hydrocarbon groups between the carboxyl groups. Depending on the mechanism and/or any subsequent hydrogenation, the aliphatic radicals may be saturated or unsaturated and the proportion of aromatic groups may also vary.

The radicals which join the carboxyl groups of the dimer fatty acids preferably comprise no unsaturated bonds and no aromatic hydrocarbon radicals.

Suitable unsaturated fatty acids for preparing the at least one C32-C40 dimer acid are known to those skilled in the art and are for example unsaturated C16 fatty acids, unsaturated C18 fatty acids and unsaturated C20 fatty acids.

A suitable unsaturated C16 fatty acid is, for example, palmitoleic acid ((9Z)-hexadeca-9-enoic acid).

Suitable unsaturated C18 fatty acids are for example selected from the group consisting of petroselinic acid ((6Z)-octadeca-6-enoic acid), oleic acid ((9Z)-octadeca-9-enoic acid), elaidic acid ((9E)-octadeca-9-enoic acid), vaccenic acid ((11E)-octadeca-11-enoic acid), linoleic acid ((9Z,12Z)-octadeca-9,12-dienoic acid), alpha-linolenic acid ((9Z,12Z,15Z)-octadeca-9,12,15-trienoic acid), gamma-linolenic acid ((6Z,9Z,12Z)-octadeca-6,9,12-trienoic acid), calendulic acid ((8E,10E,12Z)-octadeca-8,10,12-trienoic acid), punicic acid ((9Z,11E,13Z)-octadeca-9,11,13-trienoic acid), alpha-eleostearic acid ((9Z,11E,13E)-octadeca-9,11,13-trienoic acid) and betaeleostearic acid ((9E,11E,13E)-octadeca-9,11,13-trienoic acid). Particular preference is given to unsaturated C18 fatty acids selected from the group consisting of petroselinic acid ((6Z)octadeca-6-enoic acid), oleic acid ((9Z)-octadeca-9-enoic acid), elaidic acid ((9E)-octadeca-9-enoic acid), vaccenic acid ((11E)-octadeca-11-enoic acid), linoleic acid ((9Z,12Z)-octadeca-9,12-dienoic acid).

Suitable unsaturated C20 fatty acids are for example selected from the group consisting of gadoleic acid ((9Z)-eicosa-9-enoic acid), eicosenoic acid ((11Z)-eicosa-11-enoic acid), arachidonic acid ((5Z,8Z,11Z,14Z)-eicosa-5,8,11,14-tetraenoic acid) and timnodonic acid ((5Z,8Z,11Z,14Z,17Z)-eicosa-5,8,11,14,17-pentaenoic acid).

A C36 dimer acid is prepared, for example, starting from unsaturated C18 fatty acids. It is particularly preferable when the C36 dimer acid is prepared starting from C18 fatty acids selected from the group consisting of petroselinic acid ((6Z)-octadeca-6-enoic acid), oleic acid ((9Z)octadeca-9-enoic acid), elaidic acid ((9E)-octadeca-9-enoic acid), vaccenic acid ((11E)octadeca-11-enoic acid) and linoleic acid ((9Z,12Z)-octadeca-9,12-dienoic acid).

The preparation of component (B1) from unsaturated fatty acids can additionally form trimer acids; residues of unreacted unsaturated fatty acid may also remain.

The formation of trimer acids is known to those skilled in the art.

According to the invention, component (B1) preferably comprises at most 0.5% by weight of unreacted unsaturated fatty acid and at most 0.5% by weight of trimer acid, particularly preferably at most 0.2% by weight of unreacted unsaturated fatty acid and at most 0.2% by weight of trimer acid, based in each case on the total weight of component (B1).

The proportions of monomeric, dimeric, and trimeric molecules and of other by-products in the dimer acids may be determined by gas chromatography (GC), for example. The dimer acids are converted to the corresponding methyl esters by the boron trifluoride method (cf. DIN EN ISO 5509) before GC analysis and then analyzed by GC.

The dimer acids or C32-C40 dimer acid mixtures to be used can be obtained as commercial products. Examples include Radiacid 0970, Radiacid 0971, Radiacid 0972, Radiacid 0975, Radiacid 0976, and Radiacid 0977 from Oleon, Pripol 1006, Pripol 1009, Pripol 1012, and Pripol 1013 from Croda, and Unidyme 10 and Unidyme TI from Arizona Chemical.

Component (B1) has, for example, an acid number in the range from 190 to 200 mg KOH/g.

According to the invention it is preferred that component (B1) comprise 0.1 to 5% by weight of water.

Wherein according to the invention, it is more preferred that component (B1) is substantially free of water. “Free of water” in the context of the present invention means less than 1% by weight, preferably less than 0.5% by weight and especially preferably less than 0.2% by weight of water, based on the total weight of component (B1).

Component (B2)

According to the invention, component (B2) is at least one C4-C12 diamine.

In the context of the present invention, “at least one C4-C12 diamine” means either exactly one C4-C12 diamine or a mixture of two or more C4-C12 diamines.

In the context of the present invention, “C4-C12 diamine” is understood to mean aliphatic and/or aromatic compounds having four to twelve carbon atoms and two amino groups (—NH2 groups). The aliphatic and/or aromatic compounds may be unsubstituted or additionally at least monosubstituted. If the aliphatic and/or aromatic compounds are additionally at least monosubstituted, they may bear one, two or more substituents that do not take part in the polymerization of components (A) and (B). Such substituents are for example alkyl or cycloalkyl substituents. These are known per se to those skilled in the art. The at least one C4-C12 diamine is preferably unsubstituted.

Preferred components (B2) are selected from the group consisting of 1,4-diaminobutane (butane-1,4-diamine; tetramethylenediamine; putrescine), 1,5-diaminopentane (pentamethylenediamine; pentane-1,5-diamine; cadaverine), 1,6-diaminohexane (hexamethylenediamine; hexane-1,6-diamine), 1,7-diaminoheptane, 1,8-diaminooctane, 1,9-diaminononane, 1,10-diaminodecane (decamethylenediamine), 1,11-diaminoundecane (undecamethylenediamine) and 1,12-diaminododecane (dodecamethylenediamine).

Particularly preferably, component (B2) is selected from the group consisting of 1,4-diaminobutane (tetramethylenediamine), 1,5-diaminopentane (pentamethylenediamine), 1,6-diaminohexane (hexamethylenediamine), 1,10-diaminodecane (decamethylenediamine) and 1,12-diaminododecane (dodecamethylenediamine), and component (B2) is especially 1,6-diaminohexane (hexamethylenediamine).

According to the invention it is preferred that component (B2) comprises 0.1 to 50% by weight of water, preferably of 5 to 45% by weight of water, preferentially 5 to 30% by weight of water.

Component (B3)

According to the invention, component (B3) optionally present in the monomer (M) is at least one C4-C20 diacid.

In the context of the present invention, “at least one C4-C20 diacid” means either exactly one C4-C20 diacid or a mixture of two or more C4-C20 diacids.

In the context of the present invention, “C4-C20 diacid” is understood to mean aliphatic and/or aromatic compounds having two to eighteen carbon atoms and two carboxyl groups (—COOH groups). The aliphatic and/or aromatic compounds may be unsubstituted or additionally at least monosubstituted. If the aliphatic and/or aromatic compounds are additionally at least monosubstituted, they may bear one, two or more substituents that do not take part in the polymerization of components (A) and (B). Such substituents are for example alkyl or cycloalkyl substituents. These are known to those skilled in the art. The at least one C4-C20 diacid is preferably unsubstituted.

Examples of suitable components (B3) are selected from the group consisting of butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), undecanedioic acid, dodecanedioic acid, tridecanedioic acid, tetradecanedioic acid and hexadecanedioic acid.

Preferably, component (B3) is selected from the group consisting of pentanedioic acid (glutaric acid), hexanedioic acid (adipic acid), decanedioic acid (sebacic acid) and dodecanedioic acid.

Preferably component (B3) comprises 0.1 to 40% by weight of water, preferably of 5 to 30% by weight of water.

According to the invention, the copolyamide is prepared by polymerization of the lactam (A) and of the monomers (M). The polymerization of the lactam (A) and of the monomers (M) is known in principle to those skilled in the art. Typically, the polymerization of the lactam (A) and of the monomers (M) is a condensation reaction. During the condensation reaction, the lactam (A) reacts with components (B1) and (B2) present in the monomers (M) and, if present, component (B3), which may optionally be present in component (M). This causes amide bonds to form between the individual components. Typically, the lactam (A) is at least partly in an open-chain form, i.e. as the amino acid, during the polymerization.

The polymerization of the lactam (A) and of the monomers (M) can take place in the presence of a catalyst. Suitable catalysts are all catalysts known to those skilled in the art that catalyze the polymerization of the lactam (A) and of the monomers (M). Such catalysts are known to those skilled in the art. Preferred catalysts are phosphorus compounds, for example sodium hypophosphite, phosphorous acid, triphenylphosphine or triphenyl phosphite.

According to the invention, in step a) at least one lactam (A), for example selected from the group consisting of 3-aminopropanolactam, 4-aminobutanolactam, 5-aminopentanolactam (2-piperidinone; δ-lactam; δ-valerolactam), 6-aminohexanolactam (hexano-6-lactam; ε-lactam; ε-caprolactam), 7-aminoheptanolactam (heptano-7-lactam; ζ-lactam; ζ-heptanolactam), 8-aminooctanolactam (octano-8-lactam; η-lactam; η-octanolactam), 9-aminononanolactam (nonano-9-lactam; θ-lactam; θ-nonanolactam), 10-aminodecanolactam (decano-10-lactam; ω-decanolactam), 11-aminoundecanolactam (undecano-11-lactam; ω-undecanolactam) and 12-aminododecanolactam (dodecano-12-lactam; ω-dodecanolactam), preferably 5-aminopentanolactam (2-piperidinone; δ-lactam; δ-valerolactam), 6-aminohexanolactam (hexano-6-lactam; ε-lactam; ε-caprolactam), 7-aminoheptanolactam (heptano-7-lactam; ζ-lactam; ζ-heptanolactam), 8-aminooctanolactam (octano-8-lactam; η-lactam; η-octanolactam), 9-aminononanolactam (nonano-9-lactam; θ-lactam; θ-nonanolactam), 10-aminodecanolactam (decano-10-lactam; ω-decanolactam), 11-aminoundecanolactam (undecano-11-lactam; ω-undecanolactam) and 12-aminododecanolactam (dodecano-12-lactam; ω-dodecanolactam), particularly preferably 6-aminohexanolactam (hexano-6-lactam; ε-lactam; ε-caprolactam) and 12-aminododecanolactam (dodecano-12-lactam; ω-dodecanolactam), especially 6-aminohexanolactam (hexano-6-lactam; ε-lactam; ε-caprolactam), is mixed with monomers (M), preferably comprising unhydrogenated or hydrogenated C32-C40 dimer acid mixtures (B1), and also one or more diamines (B2), for example selected from the group consisting of 1,4-diaminobutane (butane-1,4-diamine; tetramethylenediamine; putrescine), 1,5-diaminopentane (pentamethylenediamine; pentane-1,5-diamine; cadaverine), 1,6-diaminohexane (hexamethylenediamine; hexane-1,6-diamine), 1,7-diaminoheptane, 1,8-diaminooctane, 1,9-diaminononane, 1,10-diaminodecane (decamethylenediamine), 1,11-diaminoundecane (undecamethylenediamine) and 1,12-diaminododecane (dodecamethylenediamine), particularly preferably comprising unhydrogenated or hydrogenated C32-C40 dimer acid mixtures (B1) and the diamine (B2) 1,6-diaminohexane (hexamethylenediamine or hexane-1,6-diamine), typically with the aid of mixing elements, for example mixing elements in feed lines or separate mixing tanks, at a temperature of 60 to 150° C.

In one preferred embodiment, in step a), the at least one lactam (A) is initially charged and the monomers (M) are added separately. This embodiment expressly comprises all lactams (A) and monomers (M) and components (B1), (B2) and (B3) thereof that are identified herein as being preferred, particularly preferred, especial or exemplary.

In case the monomers (M) are added separately, preferably the mixing in step a) comprise the steps of premixing the at least one lactam (A) with component (B1) to obtain a premixture and subsequently adding component (B2) and optionally (B3) to the premixture.

According to the inventive process the at least one lactam (A) is mixed with monomers (M) at a temperature of 60-150° C., preferably of 80 to 120° C., more preferably at a temperature of 90 to 100° C.

Preferably at least one lactam (A) is premixed with component (B1) at a temperature of 60 to 150° C., preferably 80 to 120° C. to obtain a premixture and subsequently component (B2) and optionally (B3) are added to the premixture.

It is particular preferred that before premixing the lactam (A) and the component (B1) are separately preheated to the temperature the premixing is performed at.

Preferably the premixture is a transparent solution.

Preferably in step a) after adding component (B2) and optionally (B3) to the premixture, the resulting mixture is heated to 190 to 210° C., more preferably to 195 to 201° C., most preferably to 200-205° C.

Preferably used in step a) are the following combinations of the lactam (A) with monomers (M) comprising components (B1) and (B2):

6-aminohexanolactam (A)+C32-C40 dimer acid mixture (B1), 1,6-diaminohexane (B2) or 6-aminohexanolactam (A)+hydrogenated C32-C40 dimer acid mixture (B1) and 1,6-diaminohexane (B2).

Components (B1), (B2) and optionally (B3) are preferably used here in amounts such that the molar number of the amine groups from (B2) is essentially equal to the molar number of the sum total of the carboxyl groups from (B1) and optionally (B3).

This embodiment expressly comprises all lactams (A) and monomers (M) and components (B1), (B2) and (B3) thereof that are identified herein as being preferred, particularly preferred, especial or exemplary.

In one further particularly preferred embodiment, in step a), the at least one lactam (A) is initially charged and the monomers (M) are added separately, where the lactam (A) comprises 0 to 10% by weight of water, based on the lactam (A), and the monomers (M) comprise 0 to 10% by weight of water, based on the sum total of the monomers (M), and where the molar number of the amine groups from (B2) is essentially equal to the molar number of the sum total of the carboxyl groups from (B1) and optionally (B3). This embodiment expressly comprises all lactams (A) and monomers (M) and components (B1), (B2) and (B3) thereof that are identified herein as being preferred, particularly preferred, especial or exemplary.

In one embodiment of the process according to the invention (helical tube version), the mixture obtained in step a) can, in a step (aa), be passed under elevated pressure of 3 to 9 bar, preferably 4 to 8 bar, more preferably 6 to 7 bar into a helical tube evaporator via a pressure regulation valve. Preferably simultaneous evaporation of water through a helical tube evaporator takes place to form a vapor phase and a liquid phase.

A prereactor, by way of example a stirred tank, may be connected upstream of the helical tube reactor, or the helical tube reactor may be replaced by the prereactor. This prereactor typically operates at temperatures in the range from 200 to 300° C., preferably at temperatures in the range from 250 to 290° C., and cleaves the lactam (A) such that it prepolymerizes and the polymerization in the helical tube or VK tube proceeds at an accelerated rate.

It is additionally possible to use auxiliaries, known to those skilled in the art, for improving the reaction regime, such as for example defoamers such as polydimethylsiloxane (PDMS), in process step a) according to the invention and optionally also in the VK tube or top of the VK tube. Water vapor and/or inert gas may also optionally be introduced into the mixture upstream of the helical tube. Inert gas is by way of example nitrogen, carbon dioxide or argon, or mixtures of these gases.

The helical tube evaporator is preferably a jacketed tube, in which a heating medium is conducted in the heating jacket and serves for temperature control. Industrial jacketed tubes that are preferably used according to the invention typically have a length in the range from 20 to 100 m, particularly preferably 40 to 80 m, having an internal diameter of preferably 10 to 150 mm, especially 15 to 60 mm. The helical tube evaporator brings about evaporation of water in the mixture obtained in step a). A core flow of gas (water vapor) is typically present in the helical tube evaporator in the discharge region, while a wall film is present as liquid phase. If necessary, an inert gas may be metered in at the inlet or “top” of the helical tube, for example water vapor, nitrogen, carbon dioxide or argon, or gas mixtures comprising these, for example 16 bar water vapor, in order to generate or reinforce the core flow. This may be necessary, for example, if there is insufficient water present in the mixture obtained in step a), by way of example in the case of total concentrations of the organic components of above 98% by weight. The gas added then serves as carrier gas. At the end of the helical tube evaporator there is typically phase separation between the vapor phase and liquid phase. The core flow of the gas may for example, based on the cross-sectional area of the helical tube, make up an area proportion of 15 to 35%, especially approximately 25%, while the wall film, i.e. the liquid phase, may make up 65 to 85%, especially approximately 75%, of the cross-sectional area. In this form of the process according to the invention, the helical tube evaporator may serve as a valve, since a high pressure prevails at the evaporator inlet, for example 5 to 20 bar, while at the outlet of the reactor approximately atmospheric pressure prevails. The pressure is therefore continuously reduced over the length of the helical tube. The helical tube evaporator may be constructed as described in WO 2008/049786.

During the passage of the reaction mixture through the helical tube evaporator, a temperature of 140 to 300° C., preferably 170 to 220° C., particularly advantageously 190 to 210° C., is typically established. At the same time, a reduction of pressure to preferably approximately atmospheric pressure (1 bar) and a separating-off of a gaseous phase to obtain the liquid phase take place. The decompression of the mixture obtained in step a) to approximately atmospheric pressure is thus performed by conduct through the helical tube. The gaseous phase predominantly comprises water vapor, which is separated from the organic constituents after exiting the helical tube evaporator. The vapor phase may for example be removed via a column.

The expression “approximately atmospheric pressure” generally describes atmospheric pressure (1 bar) with deviations of −0.5 to +1 bar, especially ±0.5 bar.

For an advantageous mode of operation of the helical tube, the residence times for the mixture obtained in step a) are preferably in the range from 40 to 120 seconds. If longer residence times of 3 to 10 minutes are employed, the helical tube evaporator is advantageously provided with internals such as random packings, Raschig rings or Pall rings, especially wire mesh rings, in order to achieve a high surface area.

Preferably, no chemical reaction, such as polymerization, takes place in the helical tube evaporator; instead there is only separation into vapor/gas phase and liquid phase. Water is preferably removed from the mixture obtained in step a) in vaporous form.

The two-phase mixture emerging from the helical tube and consisting of vapor phase and liquid phase, consisting of components (B1) and (B2) and also lactam (A) or comprising same, is subsequently separated in step (ab). Ideally, the two-phase mixture of vapor phase and liquid phase is directed into the vapor space at the top of the tubular polymerization zone of the vertical polymerization tube (VK tube) and the separation into vapor phase and liquid phase is conducted there.

The vapor phase obtained is likewise advantageously separated in step (ab) in a column into water vapor, components (B1) and (B2) and optionally (B3) and lactam (A), and all organic components are recycled to the polymerization, that is to say step b). The separation of the vapor phase advantageously takes place in a column with rectification. Suitable columns are for example columns with random packings, columns with structured packings, bubble-cap columns, valve tray columns or sieve tray columns having 5 to 15 theoretical plates. The column is expediently operated under the same conditions as for the separation of vapor phase and liquid phase, for example from 0.5 to 2.5 bar absolute or under the pressure of the polymerization zone. Advantageously, 0.1 to 0.5 l of water is introduced to the top of the column per kg of steam, in order to improve the separating effect. A liquid phase comprising or consisting of components (B1) and (B2) and lactam (A) is obtained as column efflux. Water vapor is obtained at the top of the column.

If, according to the preferred mode of operation, the separation is conducted in the top of the VK tube, the liquid phase comprising or consisting of diamines, dicarboxylic acids and lactams is returned to the top of the VK tube.

The organic phase from the helical tube, comprising or consisting of components (B1) and (B2) and optionally (B3) and lactam (A), and the return from the separating column are preferably mixed by stirring at the top of the vertical polymerization tube (VK tube).

The mixture obtained in step a), optionally in the prereactor, or, if steps (aa) and (ab) are conducted, the liquid phase from step (aa) and the organic components from step (ab) instead, is/are passed from the top downward through a vertical polymerization tube at polyamide-forming temperatures, and a copolyamide is obtained. The process is conducted continuously as described below.

The vertical tubular reactor used for continuously preparing polyamides, also called “polymerization tube” herein, is known and is also referred to herein and in the specialist field as a “VK tube”, and the process conducted therewith for continuously preparing polyamides or copolyamides is also referred to herein and in the specialist field as the “VK process” (V=vereinfacht [simplified], K=kontinuierlich [continuous]). The VK tube and the VK process are described by way of example in Kunststoff-Handbuch [Plastics Handbook], Volume VI (Polyamide [Polyamides]), Carl Hanser Verlag München, 1966 in Chapter 2.11.6.6, pages 190 to 194 or in Kunststoff-Handbuch 3/4, Technische Thermoplaste (Polyamide) [Industrial Thermoplastics (Polyamides)], Carl Hanser Verlag München, 1998, pages 65 to 70. The disclosure of these citations is incorporated here in its entirety by reference.

In principle, the VK process operates such that the typically liquid monomer or oligomer mixture that is to be polymerized to give the polyamide or copolyamide is introduced into the upper part of a vertical, zonally or fully heatable tube that is typically 4 to 50 m long and typically made of V4A steel, the mixture is allowed to flow vertically through the tube, which may comprise internal installations built-in, and the polymer or copolymer formed is removed at the lower end, specifically in the same quantity as mixture to be polymerized, typically liquid monomer or oligomer mixture, is introduced for polymerization into the upper part of the VK tube.

The VK process in principle also comprises an arrangement of a plurality of VK tubes, as is described by way of example in Kunststoff-Handbuch, Volume VI (Polyamide), Carl Hanser Verlag München, 1966 in Chapter 2.11.6.6, page 192, for example.

The process according to the invention operates for example such that the mixture obtained in step a) that is to be polymerized to give the copolyamide is introduced into the upper part of a vertical, zonally or fully heatable tube that is typically 4 to 50 m long and typically made of V4A steel, the mixture is allowed to flow vertically through the tube, which may comprise internal installations built-in, and the copolymer formed is removed at the lower end, specifically in the same quantity as the mixture obtained in step a) that is to be polymerized is introduced for polymerization into the upper part of the VK tube, which is referred to as a continuous process.

One version of this process according to the invention comprises an arrangement of a plurality of VK tubes, as is described by way of example in Kunststoff-Handbuch, Volume VI (Polyamide), Carl Hanser Verlag München, 1966 in Chapter 2.11.6.6, page 192, for example.

One well-suited embodiment of the process according to the invention is as follows: A temperature of preferably 250 to 285° C., especially 265 to 280° C., is generally maintained in the upper third of the VK tube. During the passage through the VK tube, the melt is temperature-controlled such that a melt at preferably 240 to 260° C. is obtained at the lower end.

The residence time in the VK tube is preferably 8 to 30 hours.

The copolyamide obtained by the process according to the invention preferably has a relative viscosity, measured as defined in the examples, of 2.0 to 3.0 and a content of water-extractable fractions of 3.5 to 12% by weight, especially 5 to 11% by weight.

The copolyamide melt obtained in this way is generally cast in strands, solidified and pelletized or pelletized directly by means of underwater pelletizing in a flowing stream of water. Suitable processes are known to those skilled in the art.

The pellets thus obtained can then be extracted continuously in countercurrent with water at a temperature of preferably 80 to 120° C. The aqueous extract thus obtained is then advantageously evaporated after adding 0.5 to 2 times the amount, based on extract caprolactam, of fresh caprolactam. A suitable process is described, for example, in DE-A 25 01 348.

In general, the extracted copolyamide is subsequently dried. Advantageously, it is subjected here to temperature control, with concomitant use of inert gases such as nitrogen or superheated water vapor as heat carrier in countercurrent, until the desired viscosity is reached, for example at a temperature of 100 to 185° C.

The polymerization according to the invention of components (A) and (B) forms the copolyamide, which therefore obtains structural units derived from component (A) and structural units derived from component (B). Structural units derived from component (B) comprise structural units derived from components (B1) and (B2) and, optionally, from component (B3).

The polymerization of component (A) and monomers (M) forms the copolyamide as a copolymer. The copolymer may be a random copolymer but it may likewise be a block copolymer.

In a block copolymer there is formation of blocks of units derived from monomers (M), and blocks of units derived from component (A). These appear in alternating sequence. In a random copolymer, there is alternation of structural units derived from component (A) with structural units derived from monomers (M). This alternation takes place randomly, for example, two structural units derived from monomers (M) may be followed by one structural unit derived from component (A), which is followed in turn by one structural unit derived from monomers (M), which is then followed by a structural unit comprising three structural units derived from component (A).

Preferably, the at least one copolyamide obtained by the process according to the invention is a random copolymer.

The at least one copolyamide obtained by the inventive process typically has a glass transition temperature (T_{G(C)}). The glass transition temperature (T_{G(C)}) is for example in the range from 20 to 50° C., preferably in the range from 23 to 47° C. and especially preferably in the range from 25 to 45° C., determined according to ISO 11357-2: 2014.

In the context of the present invention, the glass transition temperature (T_{G(C)}) of the at least one copolyamide refers in accordance with ISO 11357-2: 2014 to the glass transition temperature (T_{G(C)}) of the dry copolyamide.

In the context of the present invention, “dry” means that the at least one copolyamide comprises less than 1% by weight, preferably less than 0.5% by weight and especially preferably less than 0.1% by weight of water, based on the total weight of the at least one copolyamide. More preferably, “dry” means that the at least one copolyamide does not comprise any water, and most preferably that the at least one copolyamide does not comprise any solvent.

In addition, the at least one copolyamide typically has a melting temperature (T_{M(C)}). The melting temperature (T_{M(C)}) of the at least one copolyamide is, for example, in the range from 150 to 210° C., preferably in the range from 160 to 205° C. and especially preferably in the range from 160 to 200° C., determined according to ISO 11357-3: 2014.

The at least one copolyamide generally has a viscosity number (V_{Z(C)}) in the range from 150 to 300 ml/g, determined in a 0.5% by weight solution of the at least one copolyamide in a mixture of phenol/o-dichlorobenzene in a weight ratio of 1:1.

Preferably, the viscosity number (VZ_{(C)}), determined as described in the examples, of the at least one copolyamide is in the range from 160 to 290 ml/g and particularly preferably in the range from 170 to 280 ml/g, determined in a 0.5% by weight solution of the at least one copolyamide in a mixture of phenol/o-dichlorobenzene in a weight ratio of 1:1.

Copolyamides that can be obtained according to the process of the invention generally have 15 to 84% by weight, preferably 18 to 83% by weight, more preferably 40 to 83% by weight, and most preferably 60 to 80% by weight of nylon-6 units.

Preferred copolyamides according to the invention do not comprise polyether groups.

The copolyamides according to the invention are used in the production of films, for example films for use in the agricultural sector or films in the food packaging sector or films for industrial applications such as painting films or VARTM (Vacuum Assisted Resin Transfer Molding) films having high acid and salt stability and reduced rigidity compared to films obtained with nylon-6, while simultaneously having a high melting temperature; such films are typically obtainable by extrusion.

The copolyamides according to the invention are also used to produce molded articles in the injection molding process, profile extrusion process and blow-molding process. The molded articles produced exhibit an unexpectedly high transparency for a semicrystalline material, especially with molded articles of up to 2 mm wall thickness, and as a result can also be dyed with excellent color depth.

The copolyamide obtainable according to the invention is especially well suited for producing films, including multilayer films consisting of, or comprising, copolyamide film layers. Examples of production processes for such films include the casting process, the blowing process, the biaxially oriented polyamide film (BOPA) process or the multifilm blowing process. These processes and also films made from copolyamide are known in principle to those skilled in the art and are described, by way of example, in WO 2018/050487 A1 (BASF SE), the disclosure of which is expressly incorporated herein by way of reference. Typically, films composed of the copolyamide obtainable according to the invention are stretched when using these processes, such that a stretched copolyamide film composed of copolyamide obtainable according to the invention is obtained.

Films, including multilayer films consisting of or comprising copolyamide film layers, composed of copolyamide obtainable according to the invention are used by way of example as packaging films, for example as food packaging films. For example, said films may be used as tubular pouch packaging, as side-closed pouch packaging, as thermoformed packaging, for closable pouches and/or as pillow packaging in the food sector, too.

The invention is illustrated in more detail below with reference to examples.

### EXAMPLES

The properties of the polymer films were determined as follows.

The viscosity number of the copolyamides was determined in a 1% by weight solution of phenol/o-dichlorobenzene in a weight ratio of 1:1 at 25° C. according to DIN EN ISO 307:2007. In contrast to DIN EN ISO 307:2007, a solvent other than those disclosed must be chosen in order to bring the copolyamides into solution. Also deviating from DIN EN ISO 307:2007, instead of 0.5% by weight solutions, 1% by weight solutions were used.

As described in DIN EN ISO 307:2007 on page 15, the relative viscosities were determined from the arithmetic mean of the flow times, whereas the relative viscosity is (RV)=(t−tc/T0−T0c). Deviant from ISO: 307:2007, a solvent other than the described solvents must be chosen in order to bring the copolyamides into solution. The chosen solvent was phenol/o-dichlorobenzene in a weight ratio of 1:1. Furthermore, the polyamide solutions used contained 1% by weight of polyamide, instead of 0.5% by weight solutions disclosed in DIN EN ISO 307:2007.

The melting temperatures were determined according to ISO 11357 1: 2009 and ISO 11357-3: 2011. Two heating runs were conducted and the melting temperatures determined on the basis of the second heating run.

The densities of the polyamides were determined according to the immersion method described in EN ISO 1183-1A: 2012 using water as solvent.

In order to determine the proportion of nylon-6,36 in the copolyamide, the copolyamide was hydrolyzed in dilute hydrochloric acid (20%). This protonates the units derived from hexamethylenediamine, with the chloride ion from the hydrochloric acid forming the counterion. This chloride ion was then exchanged by means of an ion exchanger for a hydroxide ion, releasing hexamethylenediamine. The hexamethylenediamine concentration, from which the proportion of nylon-6,36 in the copolyamide can be calculated, is then quantified by titrating with 0.1 molar hydrochloric acid.

Copolyamides according to the claimed process:

### Example E-1

To 185 kg/h of caprolactam containing 2% of water at a temperature of 95° C. were added 70 kg/h of Pripol 1009 from Croda (C36 dimer acid mixture, hydrogenated), likewise heated to 95° C. Subsequently, 70% aqueous hexamethylenediamine solution was added to the transparent solution at a speed of 20 kg/h. The still transparent mixture was heated to 200-205° C. and transferred at a pressure of 7 bar into a helical tube evaporator via a pressure regulation valve. The pressure at the inlet of the helical tube evaporator was approximately 1-2 bar. The mixture emerging from the helical tube evaporator at a temperature of 195-205° C. at a slightly elevated pressure of 250 mbar was transferred to the top of a VK tube. Defoamer was simultaneously injected to the top of the VK tube at a concentration of 30-40 ppm relative to the overall input. The temperature at the top of the VK tube was approximately 260° C. The vapor phase was led to a column at the top of the VK tube and discharged after condensation. The remaining monomer mixture passed through the VK tube, which was heated in segments, wherein the temperature decreases stepwise from 265-280° C. to approximately 250° C. at the outlet of the VK tube. The VK tube was operated at the hydrostatic system pressure that the system self-established.

At the outlet of the VK tube, a nylon-6/6.36 melt was obtained, which was transferred directly via a discharge pump to an underwater pelletizing system with a subsequent extraction step and a subsequent drying step. Drying was followed by postcondensation.

The copolyamide obtained exhibited a viscosity number of 218 ml/g and a melting temperature of 199° C. The proportion of nylon-6,36 in the copolyamide, based on the total weight of the copolyamide, was 30.4% by weight, the density was 1.052 g/ml.

### Example E-2

The process described in example 1 was altered to a throughput of 160 kg/h caprolactam, 60 kg/h Pripol 1012 (C36 dimer acid mixture, unhydrogenated) and 17 kg/h of aqueous hexamethylenediamine solution.

The copolyamide obtained had a viscosity number of 217 ml/g and a melting temperature of 198° C. The proportion of nylon-6,36 in the copolyamide, based on the total weight of the copolyamide, was 28.0% by weight, the density was 1.054 g/ml.

### Example E-3

The process described in example 1 was altered to 260 kg/h of caprolactam, 50 kg/h of Pripol 1012 (C36 dimer acid mixture, unhydrogenated) and 16 kg/h of aqueous hexamethylenediamine solution.

The copolyamide obtained had a viscosity number of 222 ml/g and a melting temperature of 208° C. The proportion of nylon-6,36 in the copolyamide, based on the total weight of the copolyamide, was 16.7% by weight, the density was 1.084 g/ml.

Comparative Copolyamides:

### Comparative Example C-4

932 kg of caprolactam, 323.2 kg of Pripol 1009 (C36 dimer acid mixture, hydrogenated) from Croda (C36 dimer acid, hydrogenated), 77.84 kg of 85% by weight hexamethylenediamine solution in water and 153 kg of water were mixed in a 1930 l vessel and covered with nitrogen. The vessel was heated to an external temperature of 290° C. and the mixture was stirred at this temperature for 11 hours. Stirring was performed under elevated pressure for the first 7 h and under reduced pressure for the following 4 hours while the water formed was simultaneously distilled off. The copolyamide obtained was discharged from the vessel, extruded and pelletized. The pellets of the copolyamide obtained were extracted with 95° C. hot water for 4 times for 6 hours and subsequently dried at 90 to 140° C. under a nitrogen stream for 10 hours.

The copolyamide obtained had a viscosity number of 200 ml/g and a melting temperature of 201° C. The proportion of nylon-6,36 in the copolyamide, based on the total weight of the copolyamide, was 29.3% by weight, the density was 1.057 g/ml.

### Comparative Example C-5

932 kg of caprolactam, 322 kg of Pripol 1012 from Croda (C36 dimer acid mixture, unhydrogenated), 77.84 kg of 85% by weight hexamethylenediamine solution in water, 100 g of antifoam reagent Polyapp 2557-CTW from Polystell do Brazil and 153 kg of water were mixed in a 1930 l vessel and covered with nitrogen. The vessel was heated to an external temperature of 290° C. and the mixture was stirred at this temperature for 11 hours. Stirring was performed under elevated pressure for the first 7 h, and under reduced pressure for the following 4 hours, while water formed was simultaneously distilled off. The copolyamide obtained was discharged from the vessel, extruded and pelletized. The pellets of the copolyamide obtained were extracted with 95° C. hot water 4 times for 6 hours and subsequently dried at 90 to 140° C. under a nitrogen stream for 10 hours.

The copolyamide obtained had a viscosity number of 184 ml/g and a melting temperature of 199° C. The proportion of nylon-6,36 in the copolyamide, based on the total weight of the copolyamide, was 30.1% by weight, the density was 1.060 g/ml.

### Comparative Example C-6

1039 kg of caprolactam, 216 kg of Pripol 1009 from Croda (C36 dimer acid mixture, hydrogenated), 51.7 kg of 85% by weight hexamethylenediamine solution in water, 100 g of antifoam reagent Polyapp 2557-CTW from Polystell do Brazil and 142 kg of water were mixed in a 1930 l vessel and covered with nitrogen. The external temperature of the vessel was heated to 290° C. and the mixture was stirred at this temperature for 11 hours. Stirring was performed under elevated pressure for the first 7 hours, and under reduced pressure for the following 4 hours, while the water formed was simultaneously distilled off. The copolyamide obtained was discharged from the vessel, extruded and pelletized. The pellets of the copolyamide obtained were extracted with 95° C. hot water 4 times for 6 hours and subsequently dried at 90 to 140° C. under a nitrogen stream for 10 hours.

The copolyamide obtained had a viscosity number of 240 ml/g and a melting temperature of 206° C. The proportion of nylon-6,36 in the copolyamide, based on the total weight of the copolyamide, was 19.8% by weight, the density was 1.078 g/ml.

Determination of the Optical Quality of Films Obtained Using the Copolyamides Prepared in Examples E-1 to E-3 and Comparative Examples C-4 to C-6:

The optical quality of the thermoplastics (copolyamides) obtained in the above-described experiments was determined on the commercially available FQTS SFA-100 system from OCS®. For this purpose, polymer films were produced in a casting process using a nozzle head width of 100 mm. The system had a screw with a diameter of 25 mm and a length of 625 mm. The different extruder zone temperatures were between 240-260° C. and the nozzle temperature was 260° C. The chill roll was cooled to room temperature. The 50 μm-thick, transparent polymer films were subsequently continuously transilluminated with a 50 W halogen light radiator and the defects located in the film were monitored using a CCD line-scan camera from Nikon having 2048 pixels. The resolution of the pixels was 10×10 μm² on the cast film. Two square meters of film were examined from each material. The optical defects counted on these two square meters are listed in table 1 according to their size:

TABLE 1

| | E1 | E2 | E3 | C4 | C5 | C6 |
|---|---|---|---|---|---|---|
| <200 μm | 349 | 968 | 2511 | 7052 | 11800 | 31994 |
| 200-400 μm | 154 | 230 | 810 | 1843 | 2977 | 9687 |
| 400-600 μm | 28 | 41 | 103 | 129 | 187 | 559 |
| 600-800 μm | 1 | 4 | 27 | 32 | 24 | 42 |
| 800-1000 μm | 1 | 2 | 10 | 4 | 4 | 3 |
| >1000 μm | 0 | 2 | 4 | 4 | 3 | 1 |
| Σ | 533 | 1247 | 3465 | 9094 | 14995 | 42286 |

The optical quality of the copolyamides prepared according to the inventive continuous process is considerably improved compared to the discontinuous process described in the literature, and enables the use of the copolyamides in optically transparent molded articles.

1.-16. (canceled)

17. A process for continuously preparing copolyamides by copolymerizing at least one lactam (A) and monomers (M), comprising the steps of
a) mixing at least one lactam (A) with monomers (M) at a temperature of 60 to 150° C. and
b) passing the mixture obtained in step a) from the top downward through a vertical polymerization tube at polyamide-forming temperatures to obtain a copolyamide,
wherein the monomers (M) comprise at least one C32-C40 dimer acid (B1) and at least one C4-C12 diamine (B2) and optionally at least one C4-C20 diacid (B3).

18. The process according to claim 17, wherein
the mixing in step a) comprises a premixing of the at least one lactam (A) with component (B1) to obtain a premixture and subsequently
adding component (B2) and optionally (B3) to the premixture.

19. The process according to claim 17, wherein the component (B1) is a C32-C40 dimer acid mixture, obtainable by dimerizing unsaturated fatty acids selected from the group consisting of unsaturated C16 fatty acids, unsaturated C18 fatty acids and unsaturated C20 fatty acids.

20. The process according to claim 17, wherein the at least one lactam (A) is initially charged and the monomers (M) are added separately or together.

21. The process according to claim 17, wherein the lactam (A) comprises 0 to 10% by weight of water, based on the lactam (A), and the monomers (M) comprise 0 to 5% by weight of water, based on the sum total of their components.

22. The process according to claim 17, wherein the molar number of the amine groups from (B2) is essentially equal to the molar number of the sum total of the carboxyl groups from (B1) and optionally (B3).

23. The process according to claim 17, wherein the at least one lactam (A) is present in an amount in the range from 15 to 84% by weight and the monomers (M) are present in an amount of 16 to 85% by weight, where the sum total of the percentages by weight of components (A) and (M) adds up to 100% by weight.

24. The process according to claim 17, wherein the lactam (A) is selected from the group consisting of 3-aminopropanolactam, 4-aminobutanolactam, 5-aminopentanolactam, 6-aminohexanolactam, 7-aminoheptanolactam, 8-aminooctanolactam, 9-aminononanolactam, 10-aminodecanolactam, 11-aminoundecanolactam and 12-aminododecanolactam.

25. The process according to claim 17, wherein 6-aminohexanolactam (ε-caprolactam) is used as lactam (A).

26. The process according to claim 17, wherein component (B2) is selected from the group consisting of 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane and 1,12-diaminododecane.

27. The process according to claim 17, wherein component (B2) is 1,6-diaminohexane (1,6-hexamethylenediamine).

28. The process according to claim 17, wherein monomers (M) do not comprise polyoxyalkylene groups.

29. The process according to claim 17, wherein before step b)
(aa) the mixture obtained in step a) is supplied to a heated helical tube evaporator, in which a liquid phase and a vapor phase form at a temperature of 140 to 300° C., where a stream consisting of water vapor and/or inert gas is optionally also introduced into the mixture upstream of the helical tube and
(ab) the vapor phase formed in step (aa) is separated off from the liquid phase and separated in a column into water vapor and into organic components comprising components (B1), (B2), optionally (B3) and lactam (A),
and
(ac) the liquid phase from the helical tube of step (aa), mixed with the organic components of step (ab).

30. A copolyamide obtained by the process according to claim 17.

31. A method comprising producing fibers, films, or molded articles utilizing copolyamides as defined in claim 30.

32. The process according to claim 31 for producing films in the agricultural sector, films in the food packaging sector or films in the industrial applications sector.
